(19) United States
(12) Patent Application Publication
(10) Pub. No.: US 2002/0069140 A1
(43) Pub. Date: Jun. 6, 2002

(54) Method for combining audio-video products with on-line dictionary and system thereof

(76) Inventor: Ming-Chung Tang, Chupei City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/997,631

(22) Filed: Nov. 30, 2001

(30) Foreign Application Priority Data
Dec. 5, 2000 (CN) 089125874

(51) Int. Cl. G06F 17/60; G06F 15/00; G06F 17/00; G06F 17/21; G06F 17/24

(52) U.S. Cl. 705/27; 707/532

(57) ABSTRACT

The present invention provides a method for combining audio-video products with an on-line dictionary and a system thereof, wherein the method and the system are applied on the Internet. The present invention is characterized in that, after making an inquiry about a word by a user, the Internet Server will, according to the language level of the user, provide explanations, illustrative sentences of the word and its relating demonstrations chosen from audio-video products stored in a Dynamic Dictionary Database. The demonstrated audio-video fragments, which contain the illustrative sentences, are selected from a part of dialogs of a movie, a fragment of a song, or a portion of an e-book, and the user can decide whether to buy the audio-video product or not after getting a tryout of the demonstration. By such a easy circumstance, learning foreign languages will be more efficient and personal needs will be much met. Also, the selling of audio-video products can be increased

### BACKGROUND OF THE INVENTION

(A) Field of the Invention

The present invention relates to a method and a system for selling audio-video products, and in particular, to a method for combining audio-video products with an on-line dictionary and a system thereof. By the present invention, the user's intention to buy audio-video products and passion to learn foreign languages can be increased.

(B) Description of Related Art

As the Internet becomes more and more popular, people can therefore get more and more information from the Internet. In such a tremendous information flow, the opportunities to read documents written in foreign languages are also increasing. However, this situation is very troublesome for users who need information but are poor in foreign languages.

There are various kinds of on-line dictionaries now. They can be roughly classified into two categories: the first one locates the entire dictionary database at the client side, the second one, on the other hand, locates the whole database of the dictionary at the server side and transfers the literal meaning and illustrative sentences of the inquired word to the user through the Internet.

The defect of the first kind of on-line dictionary lies in its fixed word explanations and illustrative sentences; that is to say, this kind of dictionary provides a static dictionary database system, in which the data will only be updated when the producer develops a new version of product. The defect of the second kind of on-line dictionary lies in that it generally provides literal explanations without accompanying illustrative sentences. Moreover, both kinds of dictionaries cannot provide appropriate literal explanations and illustrative sentences according to users' language level. And, due to rigid illustrative sentences, it is difficult to create a lively and interesting learning circumstance for improving learning efficiency for users. Besides, the present on-line dictionaries are not able to further combine audio-video products selling on the basis of inquiring function of the dictionary and thus stimulate products consumption in the market.

### SUMMARY OF THE INVENTION

An object of the present invention is to provide a method for facilitating the sale of audio-video products and a system thereof, which can stimulate the urge of consumer's consumption.

Another object of the present invention is to provide an on-line dictionary inquiring method and system, which can increase users' intention for learning foreign languages.

Yet another object of the present invention is to provide an on-line dictionary inquiring method and system, which is able to provide personal illustrative sentences according to the language level or product preferences of the users.

Still another object of the present invention is to provide an interesting foreign language learning circumstance so that studying a foreign language is not anymore deemed boring and terrible.

To achieve the objects mentioned above, the present invention provides a method for combining audio-video products with an on-line dictionary and a system thereof, wherein the method and the system are applied on the Internet. The present invention is characterized in that, after making an inquiry about a word by a user, the Internet Server in the system will, according to the language level or product preferences of the user, provide explanations, illustrative sentences of the word and its relating demonstrations chosen from audio-video products stored in a Dynamic Dictionary Database. The demonstrated audio-video fragments, which contain the illustrative sentences, are selected from a part of dialogs of a movie, a fragment of a song, or a portion of an e-book. Hence, the user can decide whether to buy the audio-video product or not after viewing or listening the demonstration. By the assistance of the audio-video products, easy circumstances for foreign language learning are created, and thus learning foreign languages will be more efficient and personal needs will be much met. Therefore, compare to conventional dictionaries, the dictionary of the present invention provides a visual and hearing stimulation via the Dynamic Dictionary Database for users to get a better impression about the inquired word and thus helpful for learning.

### BRIEF DESCRIPTION OF THE DRAWINGS

The present invention is described below by way of examples with reference to the accompanying drawings which will make readers easier to understand the purpose, technical contents, characteristics and achievements of the present invention, wherein

FIG. 1 is a flow chart according to the method of the present invention;

FIG. 2 illustrates the system of the present invention;

FIG. 3 is an inquiry screen of a first embodiment of the present invention;

FIG. 4 is an inquiry screen of a second embodiment of the present invention;

FIG. 5 is an inquiry screen of a third embodiment of the present invention; and

FIG. 6 is an inquiry screen of a fourth embodiment of the present invention.

### DETAILED DESCRIPTION OF THE INVENTION

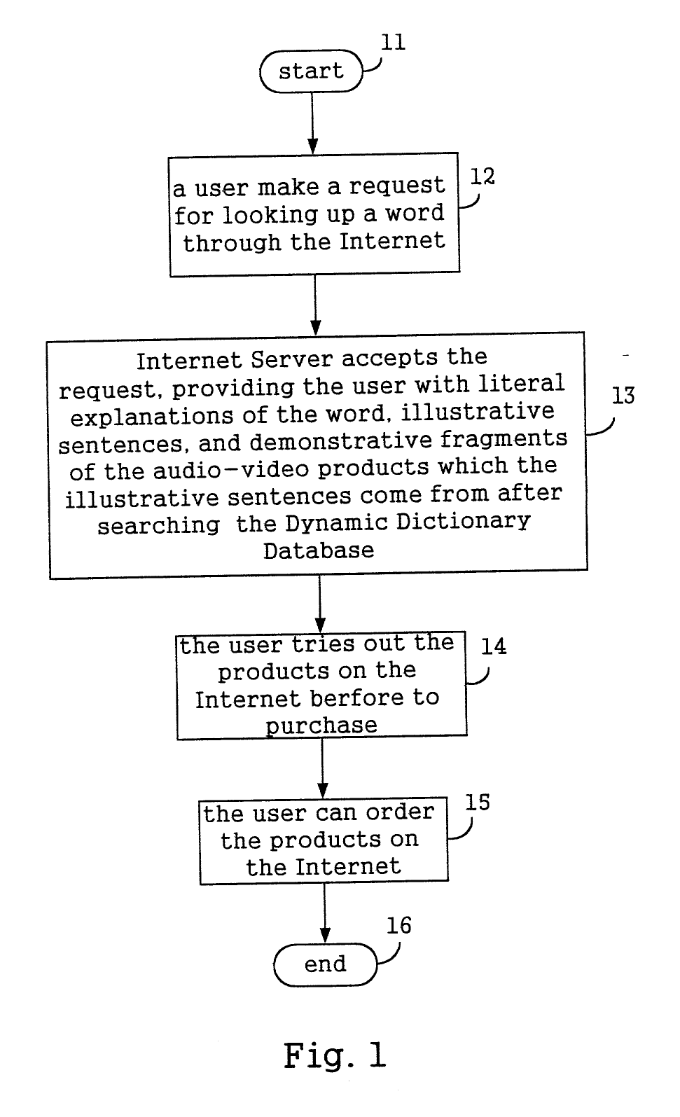

FIG. 1 is a flow chart according to the method of the present invention. The method of the present invention starts in step 11. In step 12, a user inputs a word on an inquiring screen or chooses a word in a page of the browser at the client side, the inquiry is then transferred through the Internet. In step 13, an Internet Server accepts the inquiry, searches the internal Dynamic Dictionary Database, and then provides the user with the pronunciation, morphology, explanations, illustrative sentences, and fragments of the relating audio-video products. The products can be a popular movie, a popular soap drama, an e-book, a song, a classic movie, a classic song, or a commercial advertisement. Thus, the illustrative sentence of a word will not necessarily be the same when the vocabulary is inquired at different timing, but will be different along with commercial activities, such as an audio-video product just presented to the public, a promotion of some albums, and the popular trend of audio-video products at that time. This is one of the significant characteristics of the Dynamic Dictionary Database of the present invention. In step 14, if the user is interested in the audio-video product from which the illustrative sentence is shown, a hyperlink button can be clicked on the page and the demonstrated fragment can be obtained and then displayed from an auxiliary database of the Internet Server. In step 15, if the user gets interested in the audio-video product by the display of the demonstrated fragment, he/she can directly click on the audio-video product button to view the detailed information about the product and purchase it. The audio-video product can be delivered to the user by downloading through Internet or by mail. In step 16, the method of the present invention ends.

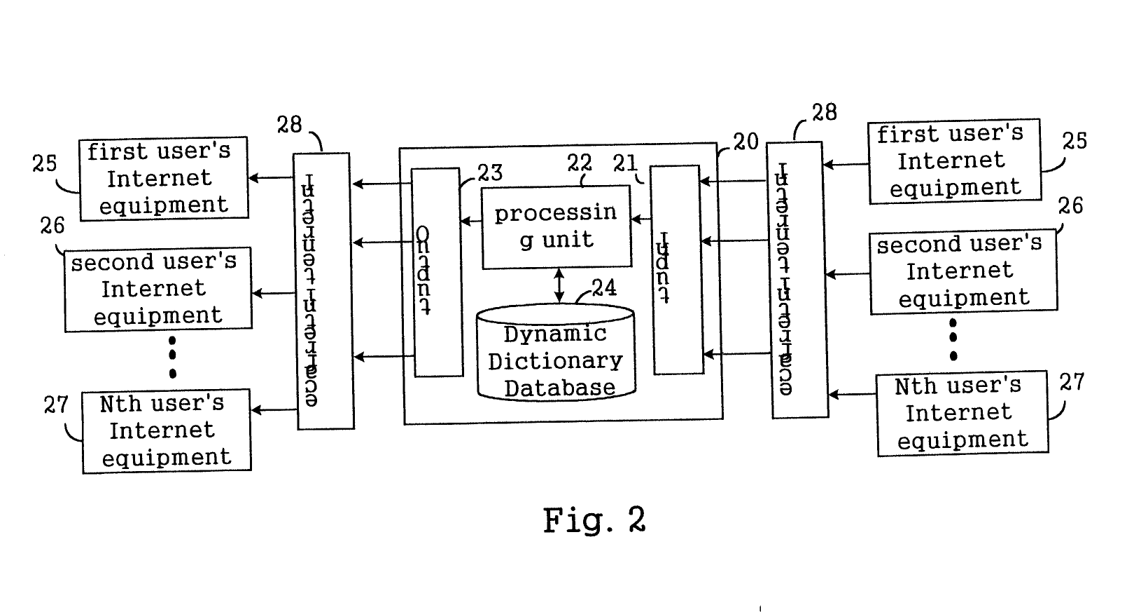

FIG. 2 illustrates the system of the present invention. The system of the present invention comprises an Internet Server 20, an Internet interface 28, a first user's Internet equipment 25, a second user's Internet equipment 26, and a nth user's Internet equipment 27. The Internet Server 20 and a plurality of user Internet equipments 25 to 27 are connected by the Internet interface 28. The plurality of user Internet equipments can be personal computers, personal digital assistants (PDAs), information appliances (IAs), or Internet connectable wireless devices, it shall be understood that the equipment for connecting to the Internet is not a limitation for the present invention. The Internet Server 20 further comprises an input 21, an output 23, a processing unit 22, and a Dynamic Dictionary Database 24. The processing unit 22 is the core of the Internet server 20; it is used to control the operation of the input 21, the output 23, and the Dynamic Dictionary Database 24. The Dynamic Dictionary Database 24 includes an illustrative sentences database for storing literal explanations and illustrative sentences, and an auxiliary database for storing demonstrative fragments of the audio-video products. Moreover, there can also be a client database for storing information about clients. When the user makes a request, the client database will provide the client's language level and music, film, or reading preferences from the user's past record, such as number of times and difficulty degree of words each time the user makes a request, as a reference for the processing unit 22 to choose the output illustrative sentence and relating audio-video product. Because the client database records each user's language level or audio-video preferences, thus the present invention can provide a personal dictionary inquiry service. Afterward, the processing unit 22 will obtain the word explanation and relating audio-video product according to the user's language level and audio-video preferences and then pass the result to the user through the Internet. The demonstrated fragments of audio-video products saved in the auxiliary database provide the user a chance to preview before ordering the product. Finally, the personalized outcome of the inquiry will be outputted and displayed on the users' Internet equipment 25 to 27 by the output 23 of the Internet Server 20.

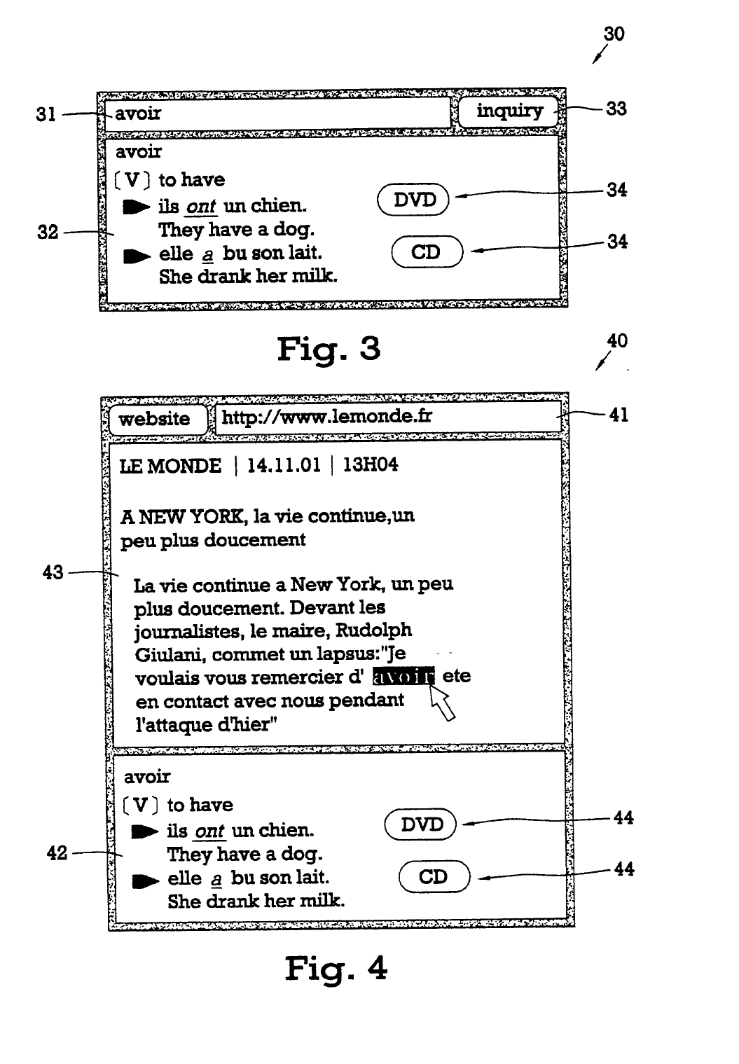

FIG. 3 is an inquiry screen of a first embodiment of the present invention. The inquiry screen 30 comprises an input frame 31, a display frame 32, and a request frame 33. The user can input the word he/she wants to inquire in the input frame 31, and then click on the inquiry button 33 after completing the input. After the Internet Server 20 on the other end of the Internet accepting the request and searching in the Dynamic Dictionary Database, the literal explanation of the inquired word, the illustrative sentences that are suitable for the user's language level and audio-video preferences, and the buttons for the audio-video products 34 will be shown on the display frame 32.

FIG. 4 is an inquiry screen of a second embodiment of the present invention. The inquiry screen 40 is an embedded browser application comprising a website frame 41, a display frame 42, and a browsing frame 43. A user can input a website address at the website frame 41, and then gets a corresponding web page at the browsing frame 43. If the user wants to know more about the words at the web page, he/she can directly click on the word and the request will be transferred to the web server on the other end of the Internet immediately due to the on-line status. After the web server searching in the Dynamic Dictionary Database, the literal explanation of the inquired word, the illustrative sentences that are suitable for the user's language level or audio-video preferences, and the buttons of the audio-video products 44 will be shown on the display frame 42.

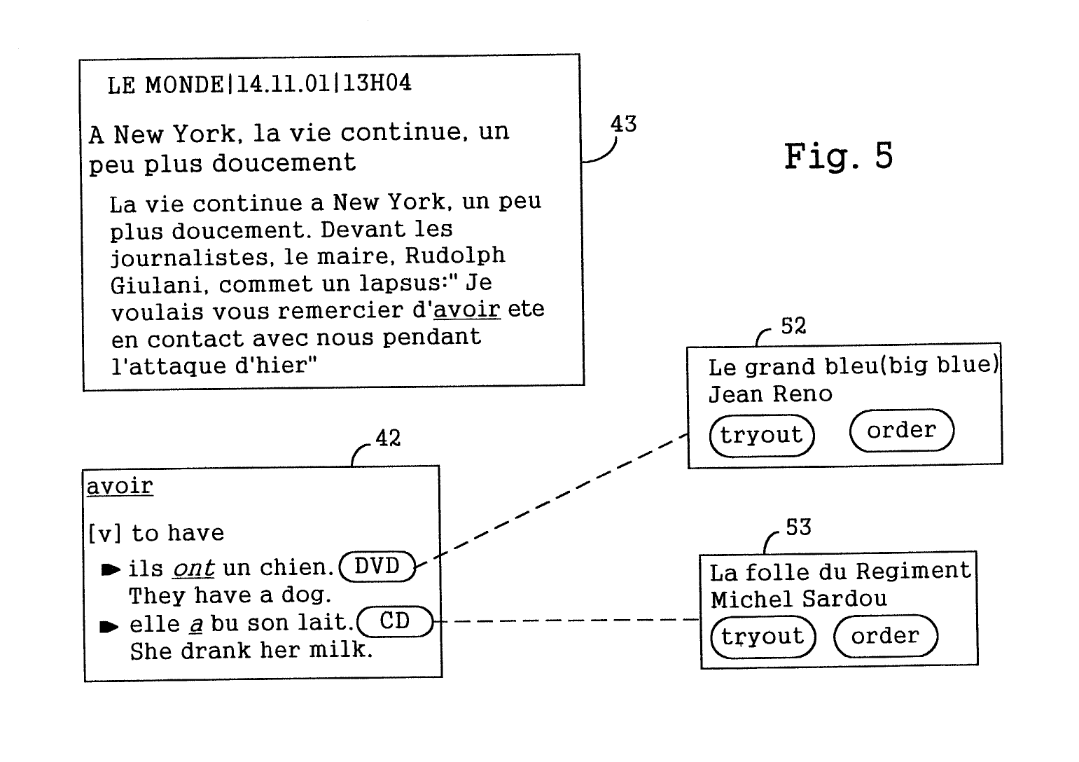

FIG. 5 is an inquiry screen of a third embodiment of the present invention. After a user clicking on the image button (DVD or CD) in the display frame 42, a first popup page 52 will appear; or after the user clicking on the musical note button in the display frame 42, a second popup page 53 will appear. Each of the first popup page 52 and the second popup page 53 comprises a demonstration button and an order button, the user can click on the order button for directly ordering the product, or try out the demonstration first to decide whether to order the product or not. As for the delivery, the user can choose to download the product on the Internet or delivery by mail, it should be understood that delivery method is not a limitation of the present invention.

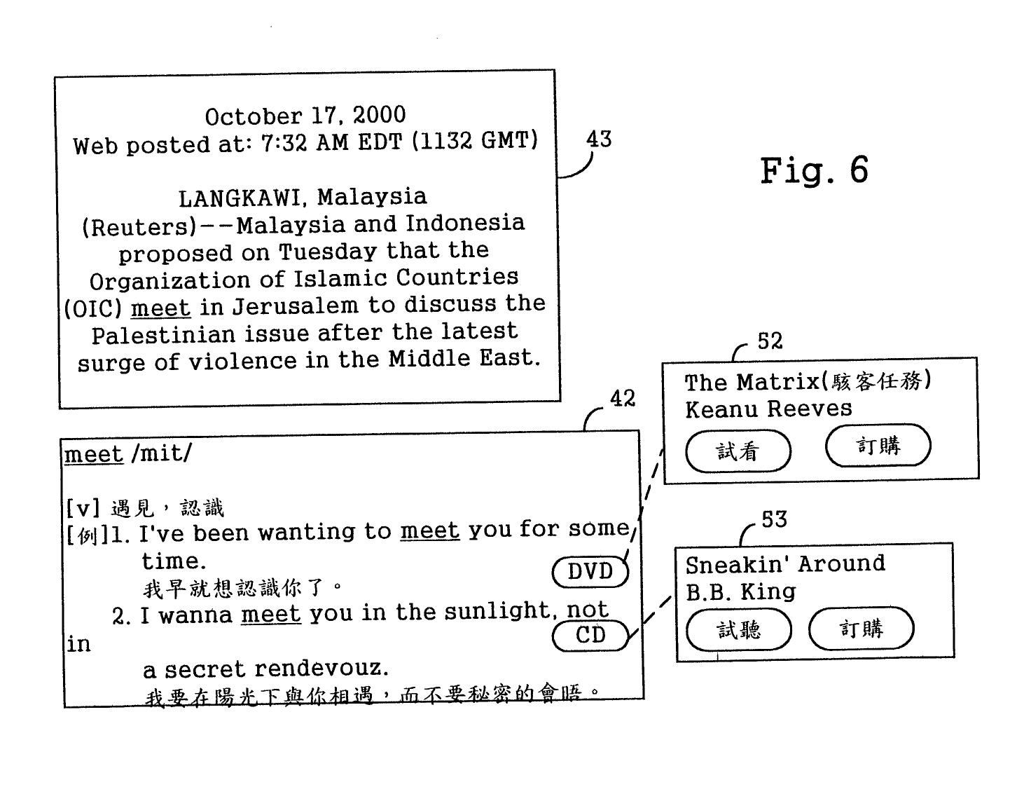

FIG. 6 is an inquiry screen of a fourth embodiment of the present invention. As shown in the figure, the present embodiment is an English-Chinese dictionary (inquiring the word “meet”). The lay out is very much the same with the one in FIG. 5; the only difference lies in the language transformation. This indicates that the dictionary of the present invention can support different kinds of language transformation and adjust the examples according to the language the user request for.

The system of the present invention can further set a word explanation database in the user's Internet equipment for the inquiring function when the Internet is congested or not connected. The word explanation database includes the user's inquiry history which is corresponding to the user's information stored in the client database of the Internet Server. According to the information of the client database, the application program at the client side will automatically obtain the data of the illustrative sentences database from the Internet Server when the Internet is connected from time to time so as to update the data of the word explanation database at the client side. Thus, even a user unexpectedly cannot connect to the Internet but still needs to use the dictionary, the word explanation database at the client side can provide a promptly support. However, since the space at the client side is not so sufficient as it is at the server side, the word explanation database provides only explanations and illustrative sentences of the words without information about the audio-video products from which the illustrative sentences originates, as in the on-line status.

The technical contents and features of the present invention have been disclosed in the above embodiments and will not be limited thereto. Persons skilled in the art can possibly modify or chance the details in accordance with the present invention without departing from the technologic ideas and spirits of the invention.

What is claimed is:

1. A method for combining audio-video products with an on-line dictionary, said method is applied on the Internet, comprising the following steps:
making an inquiry about a word through the Internet by a user;
after a Internet Server accepting the inquiry, literal explanations, illustrative sentences of the word, and relating demonstrative fragments of the audio-video products are provided to the user by a Dynamic Dictionary Database; and
deciding whether to purchase the products on the Internet by the user.

2. The method according to claim 1, wherein after the Internet Server accepting the inquiry, the Internet Server searches for the user's audio-video preferences in the Dynamic Dictionary Database, and then provides the user with the suitable literal explanations, the illustrative sentences of the word, and the demonstrative fragments of the audio-video products.

3. The method according to claim 1, wherein the after the Internet Server accepting the inquiry, the Internet Server searches for the user's language level and audio-video preferences in the Dynamic Dictionary Database, and then provides the user with the suitable literal explanations, the illustrative sentences of the word, and the demonstrative fragments of the audio-video products.

4. The method according to claim 1, wherein the user can get a tryout of the demonstrative fragments before purchasing the product.

5. The method according to claim 1, wherein the demonstrative fragments of the audio-video products are parts of commercial movies, soap dramas, or e-books.

6. The method according to claim 1, wherein the user can directly click on a word at the browser page to inquiry the word.

7. A system for combining audio-video products with an on-line dictionary, said system is applied on the Internet, comprising:
at least a user's Internet equipment, the equipment includes an inquiry interface for making inquires about words, and
an Internet Server, after accepting the inquiry from a user, for providing the user with literal explanations, illustrative sentences of the word, and demonstrative fragments of the audio-video products according to the user's language level and audio-video preferences.

8. The system according to claim 7, wherein the inquiry interface is embedded in a browser application.

9. The system according to claim 7, wherein the user's Internet equipment further includes a word explanation database for the user to access the dictionary even when the Internet cannot be connected.

10. The system according to claim 9, wherein the user's Internet equipment can download updated literal explanations and illustrative sentences when the Internet is connected, and then store them to the word explanation database.

11. The system according to claim 7, wherein the Internet Server further provides demonstrative fragments of the audio-video products for users to get a tryout on the Internet before purchasing them.

12. The system according to claim 11, wherein the demonstrative fragments of the audio-video products are parts of commercial movies, soap dramas, or e-books.

13. The system according to claim 7, wherein the Internet Server comprises a Dynamic Dictionary Database, and the Dynamic Dictionary Database further includes:
an illustrative sentences database for saving the literal explanations and the illustrative sentences of the words,
a client database for recording users' language levels and audio-video preferences, and
an auxiliary database for storing demonstrative fragments of the audio-video products.
